(19) United States
(12) Patent Application Publication
(10) Pub. No.: US 2020/0371256 A1
(43) Pub. Date: Nov. 26, 2020

(54) RADIOMETRIC FILL LEVEL MEASURING DEVICE WITH REFERENCE SCINTILLATOR

(71) Applicant: VEGA Grieshaber KG, Wolfach (DE)

(72) Inventors: Winfried RAUER, Fischerbach (DE); Matthias HARTER, Schenkenzell (DE)

(73) Assignee: VEGA Grieshaber KG, Wolfach (DE)

(21) Appl. No.: 16/867,244

(22) Filed: May 5, 2020

(30) Foreign Application Priority Data
May 24, 2019 (EP) 19 176 563.5

(51) Int. Cl. G01T 1/204; G01T 1/167

(52) U.S. Cl. CPC G01T 1/204; G01T 1/167

(57) ABSTRACT

A method for compensating a measurement deviation of a first scintillator and/or a photodetector of a radiometric fill level measuring device is provided, including detecting, by a second scintillator, radioactive emissions from the second scintillator; transmitting, in response to radioactive emissions, a first light signal from the first scintillator and a second light signal from the second scintillator, the first light signal being different from the second light signal; receiving, by the photodetector, the first light signal from the first scintillator and the second light signal from the second scintillator, and converting the light signals into electrical signals; comparing the electrical signals with deposited reference signals by means of a comparator; and adjusting the gain of the photodetector in response to comparing the electrical signals and stored reference signals. A radiometric fill level measuring device for fill level measurement, for density measurement, and/or for mass flow measurement is also provided.

### CROSS-REFERENCE TO RELATED APPLICATIONS

This application claims the benefit of the filing date of European Patent Application No. 19 176 563.5, filed on 24 May 2019, the entire content of which is incorporated herein by reference.

### TECHNICAL FIELD

The invention relates to a radiation-based fill level measuring device for fill level measurement, density measurement, and/or mass flow measurement. In particular, the invention relates to a method for compensating for a measurement deviation of a scintillator and/or of a photodetector used in the radio-metric fill level measuring device. Further, the invention relates to a use, a program element, and a computer-readable medium.

### BACKGROUND

A radiometric level measuring system may be used, for example, to indicate a certain level of a product, e.g., in a vessel, i.e., to indicate whether a predefined upper, lower, or other limit of the level in the vessel has been reached. The container may be a vessel or a measuring tank of any shape. The tank may also be a channel, for example a stream or river bed.

For example, the radiometric fill level measurement device may use a gamma emitter to emit a radiometric signal and/or gamma radiation that may be received by a detector for measurement purposes. The detector may include a scintillator that emits a light signal when it is hit, for example, by a gamma ray. In at least some scintillators, the amplitude and/or frequency of the light signal may depend on, for example, the temperature of the scintillator, which may cause measurement deviations compared to a reference measurement. Such measurement deviations may influence the measurement accuracy.

### SUMMARY

It is a task of the invention to provide a radiation-based fill level measuring device.

This task is solved by the subject of the independent patent claims. Further developments of the invention result from the sub-claims and the following description.

A first aspect of the invention concerns a method for compensation of a measurement deviation of a first scintillator and/or a photodetector of a radiation-based fill level measuring device for fill level measurement, comprising the steps of:

detecting, by means of a second scintillator, radioactive emissions from the second scintillator;

transmitting, in response to radioactive emissions, a first light signal from the first scintillator and a second light signal from the second scintillator, the first light signal being different from the second light signal;

receiving, by means of the photodetector, the first light signal from the first scintillator and the second light signal from the second scintillator, and converting the light signals into electrical signals;

comparing, by means of a comparator, the electrical signals with stored reference signals; and

adjusting a gain of the photodetector in response to the comparison of the electrical signals and stored reference signals.

A radiation-based level measuring system is used, for example, for a fill level measurement and/or for other measurements of a product, e.g., measurement of a level, density and/or flow of the product or medium. The radiation-based level measuring system comprises the first scintillator and the photodetector. The scintillator emits a light signal when it is hit, e.g., by radioactive emissions. The first scintillator is the primary scintillator, whose measurement results are used by the radiation-based level transmitter. The photodetector may be a photomultiplier, photomultiplier tube (PMT), micro channel plate photomultiplier (MCP-PMT, MCP), silicon photomultiplier (e.g., avalanche photodiode), photodiode array, and/or other detector. The first scintillator and/or photodetector may have a measurement deviation, which is caused, for example, by temperature differences and/or aging of at least one of these components.

In one step of the method, a second scintillator detects radioactive emissions originating from its own radioactive components.

In one step of the method, in response to radioactive emissions, the first scintillator sends a first light signal and the second scintillator sends a second light signal. The first light signal differs from the second light signal, e.g., in amplitude, color, and/or other characteristics.

In one step of the method, the photodetector receives the first light signal from the first scintillator and the second light signal from the second scintillator. The photodetector converts the light signals into electrical signals or electrical pulses. To evaluate the electrical pulses generated by the photodetector, an amplifier with a downstream discriminator, and/or an amplifier with downstream pulse amplitude measurement may be used.

In one step of the method, a comparator compares the electrical signals with stored reference signals. The comparator may be implemented as hardware and/or as software. The hardware component may, for example, be implemented as special hardware and/or, for example, as part of a chip that also contains a processor. The temperature responses of the first and the second scintillator and/or the difference of both temperature responses are stored in the fill level measuring device, e.g., a memory, particularly in a non-volatile memory, within the device and/or in a memory or database to which the device has access. The temperature curves may be present and/or stored, e.g., as measured values and/or as deviations of measured values from a “standard measured value” (e.g., 20° C.) as a function of temperature. The first and the second scintillator may have different materials; these different materials may have different temperature curves. The temperature curves may be measured, e.g., during the manufacture of the level measuring device. The temperature curves may also be measured—additionally or alternatively—during operation of the level measuring device. Temperature curves measured in this way may be used, for example, to create a time series, which may be used to analyze the aging of components of the level measuring device.

In one step of the method, an amplification of the photodetector and/or a subsystem comprising the first scintillator and the photodetector is adjusted in response to the comparison of the electrical signals and the stored reference signals. The adjustment may be done, for example, by changing a voltage of a high-voltage power supply acting on the photodetector. The adjustment may be done, e.g., by changing the amplification of an amplifier downstream of the photodetector. The comparison and/or adjustment may be performed by means of a processor or controller and/or by means of special hardware, e.g., a DSP (Digital Signal Processor), an analog computer, and/or an artificial neural network (ANN).

By this method, measurement deviations of the first scintillator and/or of the photodetector are advantageously at least partially compensated. In addition, this method has a high stability against aging by using properties of the second scintillator as reference value.

In some embodiments, the method comprises a further step of determining the current temperature and the reference signal stored to match the temperature. This relationship is sometimes referred to as “temperature response”. The current temperature may be measured, e.g., directly at the measuring devices, indirectly, e.g., by means of a remote thermometer, and/or indirectly by closing the external temperature of the measuring devices to the current temperature of the measuring devices. Thus the accuracy of the measurements and/or the compensation may be further improved.

In some embodiments, the measurement deviation is a function of the temperature, and the reference signals stored to match the temperature are stored in a comparison table. The reference signal may, for example, be stored and/or may be available as an array of reference signals which assigns a reference signal to a certain temperature. This may contribute to a fast and/or structured access to the measured values of the reference signals.

In some embodiments the first scintillator is adjacent to the second scintillator. The neighborhood may be realized, e.g., by mechanical and/or thermal coupling. The neighborhood may, for example, improve the reception of the light signals by the photodetector. Furthermore, a very similar temperature of both scintillators may be achieved.

In one version, the measurement deviation of the first scintillator and/or the photodetector is caused by aging of the first scintillator and/or the photodetector. The method may therefore also take these—and/or other—effects into account, which may cause a measurement deviation.

In some embodiments, a distinction is made between the first light signal from the first scintillator and the second light signal from the second scintillator on the basis of a different propagation time, a different color and/or a different intensity of the light signals. The discrimination may be performed by means of a discrimination device. By selecting the discriminating features, the discriminator may, for example, be simplified and/or offer improved precision.

In some embodiments, the second scintillator is one of the following scintillators: Lutetium Aluminium Garnet (LuAG), Cerium-doped Lutetium Yttrium Silicate (LYSO), Lutetiumoxyorthosilicate (LSO), Yttrium Aluminium Perovskite (Cerium) (YAP:Ce), Yttrium Aluminium Garnet (YAG), and/or a similar scintillator. These types of scintillators not only detect light signals, but also emit radiation due to their own radioactivity. In addition, at least some of these scintillators show little or very little aging.

In some embodiments, the process has a further step:

transmitting an alarm if neither the first light signal is transmitted and/or received by the first scintillator nor the second light signal is transmitted and/or received by the second scintillator.

By using the second scintillator, light signals or pulses are always detected in a normal operating condition of the radiation-based level measurement system. If these pulses are no longer detected, there may be a fault in the measurement chain, for example a defect in the amplifier, photodetector and/or other components of the level measurement system. In this case, an alarm is sent and predefined actions may be taken, e.g., maintenance may be initiated.

In one embodiment, the second scintillator is shielded from the gamma emitter and/or another external radiation source. This achieves a clear separation of the first and the second scintillator, so that the first scintillator receives only radioactive emissions from the gamma emitter and/or another external radiation source, but the second scintillator receives only radioactive emissions from the second scintillator itself. This may contribute to a clearer, methodical separation of the first scintillator (e.g., for measurement) from the second reference scintillator (e.g., for reference).

A further aspect concerns a radiation-based level measuring system for level measurement, density measurement and/or mass flow measurement. The fill level measuring device comprises:

a first scintillator configured to detect radioactive emissions from a gamma emitter and, in response to the radioactive emissions, to emit a first light signal;

a second scintillator configured to detect radioactive emissions from the second scintillator and, in response to its own radioactive emissions, to transmit a second light signal, the second light signal being different from the first light signal;

a photodetector configured to receive and convert the first light signal and the second light signal into electrical signals; and

a comparator configured to compare the electrical signals with stored electrical reference signals,

wherein the gain of the photodetector is adjusted in response to the comparison.

In one embodiment, the radiometric level measuring device further comprises a discriminating device arranged to discriminate the first light signal and the second light signal on the basis of a different signal transit time, a different color, and/or intensity of the first light signal and the second light signal. These different signal propagation times may be distinguished, for example, by arranging a photodetector at a first end (e.g. “bottom”) of the first scintillator and another photodetector at a second end (e.g. “top”) of the first scintillator and at the second scintillator. Thus, the signals of the second scintillator may be separated by the different signal propagation times with respect to the two photodetectors.

In one embodiment, the second scintillator is one of the following scintillators: Lutetium Aluminium Garnet (LuAG), Cerium-doped Lutetium Yttrium Silicate (LYSO), Lutetiumoxyorthosilicate (LSO), Yttrium Aluminium Perovskite (Cerium) (YAP:Ce), Yttrium Aluminium Garnet (YAG), and/or a similar scintillator.

A further aspect relates to a use of a level measuring device as described above and/or below for radiation-based fill level measurement, for level limit measurement, for flow measurement, for mass flow measurement, and/or for density measurement.

A further aspect relates to a program element which, when executed on a processor or processor unit of a measuring device, instructs the measuring device to carry out the method described above and/or below.

A further aspect relates to a computer-readable medium on which said program element is stored.

For further clarification, the invention is described by means of embodiments illustrated in the figures. These embodiments are only to be understood as examples, but not as limitations. The representations in the following figures are schematic and not to scale.

### BRIEF DESCRIPTION OF THE DRAWINGS

FIG. 1 shows a schematic sketch of a radiation-based fill level measuring device according to an embodiment;

FIGS. 2a to 2e show schematic sketches of a subsystem according to an embodiment; and

FIG. 3 shows a flowchart of a method according to an embodiment.

### DETAILED DESCRIPTION OF EMBODIMENTS

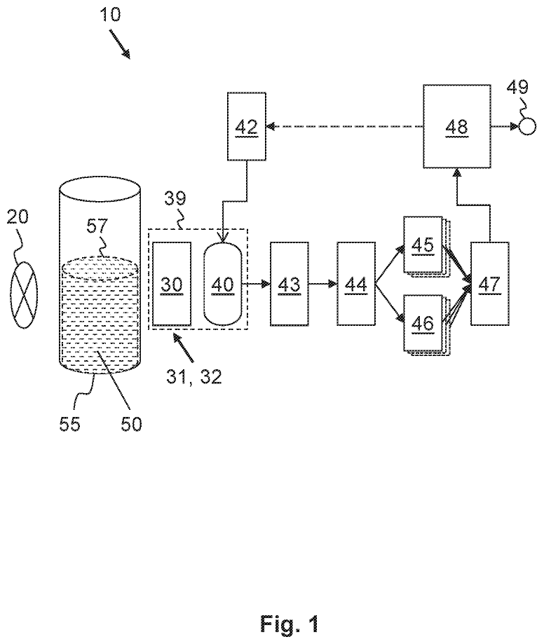

FIG. 1 shows a schematic sketch of a radiometric fill level measuring device 10. The functional components of the fill level measuring device 10 are shown as logical blocks. At least some of these logical blocks may be implemented as hardware, as software, or also partly as hardware and partly as software. The logical blocks may be physically separated or located on the same component. For example, the comparator 47 may be implemented as independent hardware, as part of a chip, and/or as software running on the processor unit 48.

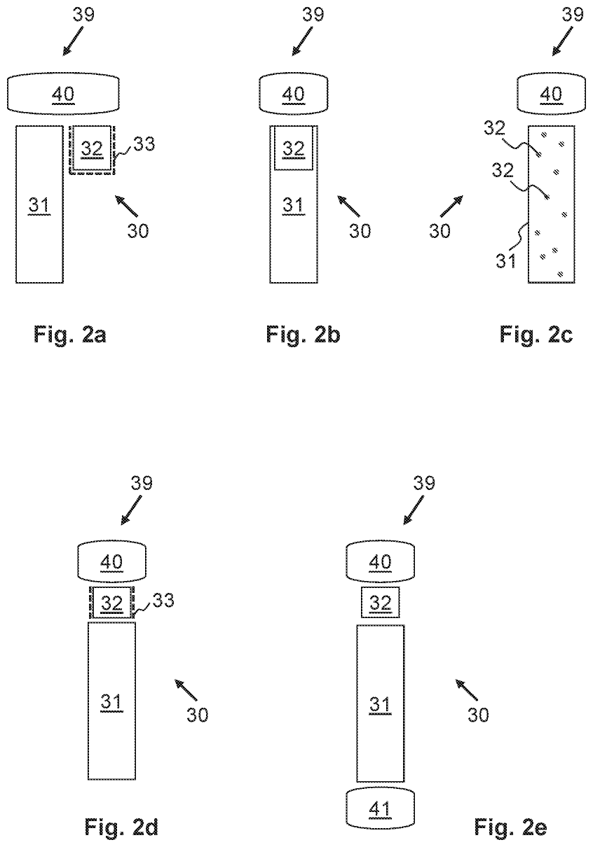

The radiometric fill level measuring device 10 has a scintillator arrangement 30 that is configured to detect radioactive emissions from a gamma emitter 20. Between the gamma emitter 20 and the scintillator arrangement 30 there is a container 55, which contains a filling material 50 with a filling level 57. The scintillator arrangement 30 may have a first scintillator 31 and a second scintillator 32. The scintillators 31 and 32 emit light signals in response to radioactive emissions. In this drawing, the scintillator assembly 30 is combined with a photodetector 40 to form a subsystem 39 (dashed), which is shown below (i.e., in FIGS. 2a to 2e) in various embodiments.

The light signals from the first and second scintillator are received by the photodetector 40 and converted into electrical signals. Photodetector 40 may be a photomultiplier or photomultiplier tube (PMT). Such a photomultiplier has a high-voltage power supply 42, which may be controlled, e.g., by a computing and control unit or processor unit 48. After the photodetector 40 an amplifier 43 is arranged, which amplifies the electrical signals from the photodetector 40. A discriminator or discriminating device 44 is arranged downstream, which divides the electrical signals from the amplifier 43 into signals 45, 46, which are caused by radioactive emissions and are detected by the first scintillator 31 and the second scintillator 32, respectively. The division may, for example, take place based on a different signal propagation time, a different color, and/or intensity of the first or the second light signal. A downstream comparator 47 is set up to compare the electrical signals—for example, the electrical signals resulting from the second light signal—with stored electrical reference signals. The comparator 47 may be implemented as hardware and/or software. The hardware component may be implemented, for example, as special hardware and/or, for example, as part of a chip that also contains a processor or may also be located in the processor. The electrical reference signals may, for example, maintain temperature curves. The temperature responses may be measured, e.g., during the manufacture of the fill level measuring device 10. The temperature responses may be measured additionally or alternatively also during operation of the fill level measuring device 10. The measured data may be further processed in the processor unit or calculation and control unit 48, e.g., a format adjustment and/or further calculations may be carried out. The measurement data are available at an output 49. This may be implemented, e.g., in the form of a 4 . . . 20 mA loop current, and/or as a field bus—e.g., with a protocol according to HART, Profibus, Foundation Fieldbus, and/or as a proprietary protocol. The measurement data may be available in a format suitable for communication via wireless local area network (WLAN) and/or for a protocol such as LTE, 5G, etc.

FIGS. 2a to 2e show schematic sketches of subsystem 39 according to an embodiment. Subsystem 39 comprises the scintillator arrangement 30 and the photodetector 40. In particular, different relative arrangements of scintillator arrangement 30 and photodetector 40 are shown. It becomes clear, for example, that in all the embodiments shown, the first scintillator 31 and the second scintillator 32 are arranged adjacent to each other.

FIG. 2a shows an embodiment in which the first scintillator 31 and the second scintillator 32 are arranged side-by-side in front of the photodetector 40. FIG. 2b shows an embodiment in which the second scintillator 32 is incorporated into the first scintillator 31 or is arranged within a contour of the first scintillator 31. In FIG. 2c, the second scintillator 32 is incorporated into the first scintillator 31 in a “dissolved” form and/or distributed within a contour of the first scintillator 31. FIG. 2d shows an embodiment where the second scintillator 32 is placed between the first scintillator 31 and the photodetector 40. Light pulses from the first scintillator 31 pass at least partially through the second scintillator 32 before they are detected by the photo-detector 40. In FIG. 2e, the second scintillator 32 is arranged between the first scintillator 31 and the photodetector 40, similar to FIG. 2d. Furthermore, a further photodetector 41 is shown, which preferably or exclusively receives signals from the first scintillator 31. This design can also be used to detect the different light signals on the basis of their different signal propagation times.

The embodiments shown and/or other embodiments may have an optional partition wall 33 by which the second scintillator 32 is shielded from the gamma emitter 20 and/or another external radiation source. For example, as shown in FIG. 2a, the partition wall 33 can be arranged in a U-shape around the second scintillator 32 so that its light radiation is detected by the photodetector 40, but the second scintillator 32 does not receive and/or detect any radioactive emissions. In the embodiment of FIG. 2d, the partition wall 33 can be arranged laterally around the second scintillator 32 so that its light radiation is detected by the photodetector 40 but the second scintillator 32 does not receive and/or detect any radioactive emissions.

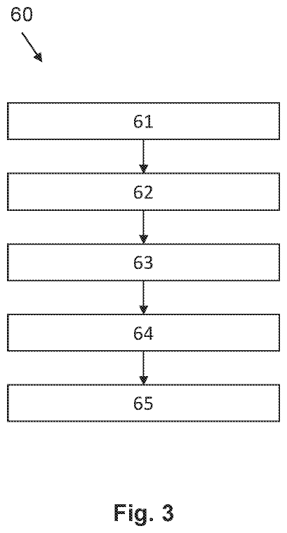

FIG. 3 shows a flowchart 60 of a method according to an embodiment. In a step 61, radioactive emissions of the second scintillator 32 are detected by means of a second scintillator 32 (see FIGS. 2a to 2e). In a step 62, in response to radioactive emissions, a first light signal is transmitted from a first scintillator 31 and a second light signal is transmitted from the second scintillator 32. The first light signal differs from the second light signal, e.g., in terms of amplitude, transit time, and/or color. In a step 63, the first light signal is received by the first scintillator 31 and the second light signal is received by the second scintillator 32 by means of the photodetector 40, and the light signals are converted into electrical signals. In a step 64, the first light signal and the second light signal are compared, e.g., by means of a comparator 47 (see FIG. 1). In a step 65, a gain of the photodetector 40 and/or other components of the radiometric fill level measuring device 10 is adjusted in response to the comparison of the electrical signals and stored reference signals.

In addition, it should be noted that “comprehensive” and “comprising” do not exclude other elements or steps and the indefinite articles “a” or “one” do not exclude a multitude. It should also be noted that features or steps described with reference to one of the above embodiments may also be used in combination with other features or steps of other embodiments described above. Reference marks in the claims are not to be considered as restrictions.

### LIST OF REFERENCE SIGNS

10 radiation-based measuring device

20 gamma emitter

30 scintillator arrangement

31 first scintillator

32 second scintillator

33 optional partition wall

40 photodetector

41 further photodetector

42 high-voltage power supply

43 amplifier

44 discriminating device

45, 46 signals

47 comparator

48 processor unit

49 output

50 filling material

55 container

57 filling level

60 flowchart

61-65 steps

1. A method for compensating a measurement deviation of a first scintillator and/or of a photodetector of a radiometric fill level measuring device for fill level measurement, comprising:
detecting, by a second scintillator, radioactive emissions of the second scintillator;
transmitting, in response to radioactive emissions, a first light signal from the first scintillator and a second light signal from the second scintillator, the first light signal being different from the second light signal;
receiving, by the photodetector, the first light signal from the first scintillator and the second light signal from the second scintillator, and converting the received light signals into electrical signals;
comparing, by a comparator, the electrical signals to stored reference signals; and
adjusting a gain of the photodetector in response to the comparing of the electrical signals and stored reference signals.

2. The method of claim 1, further comprising:
determining a current temperature and the reference signal stored in a manner suitable for the current temperature.

3. The method of claim 1,
wherein the measurement deviation is a function of temperature, and the reference signals to match the temperature are stored in a comparison table.

4. The method of claim 1,
wherein the first scintillator is adjacent to the second scintillator.

5. The method of claim 1,
wherein the measurement deviation of the first scintillator and/or of the photodetector is caused by aging of the first scintillator and/or of the photodetector.

6. The method of claim 1,
wherein a discrimination, by a discriminating device, of the first light signal from the first scintillator and of the second light signal from the second scintillator, is performed on the basis of a different transit time, a different color, and/or a different intensity of light signals.

7. The method of claim 1,
wherein the second scintillator is one of the following scintillators:
lutetium aluminum garnet (LuAG), cerium-doped lutetium yttrium silicate (LYSO), lutetiumoxyorthosilicate (LSO), yttrium aluminum perovskite (cerium) (YAP:Ce), yttrium aluminum garnet (YAG), and/or a similar scintillator.

8. The method of claim 1, further comprising:
transmitting an alarm when neither the first light signal is transmitted and/or received by the first scintillator nor the second light signal is transmitted and/or received by the second scintillator.

9. The method of claim 1,
wherein the second scintillator is shielded from a gamma emitter and/or a further external radiation source.

10. A radiometric fill level measuring device for fill level measurement, for density measurement, and/or for mass flow measurement, the fill level measuring device comprising:
a first scintillator configured to detect radioactive emissions from a gamma emitter and, in response to the radioactive emissions, to emit a first light signal;
a second scintillator configured to detect radioactive emissions from the second scintillator and, in response to the radioactive emissions, to transmit a second light signal, the second light signal being different from the first light signal;
a photodetector configured to receive and to convert the first light signal and the second light signal into electrical signals; and
a comparator configured to compare the electrical signals with stored electrical reference signals,
wherein a gain of the photodetector is adjusted in response to a comparison of the electrical signals and stored reference signals.

11. The device of claim 10, further comprising:
a discriminating device configured to discriminate the first light signal and the second light signal based on a different signal travel time, a different color, and/or an intensity of the first light signal and the second light signal.

12. The device of claim 10,
wherein the second scintillator is one of the following scintillators:
lutetium aluminum garnet (LuAG), cerium-doped lutetium yttrium silicate (LYSO), lutetiumoxyorthosilicate (LSO), yttrium aluminum perovskite (cerium) (YAP:Ce), yttrium aluminum garnet (YAG), and/or a similar scintillator.

13. A nontransitory computer-readable storage medium having a program stored therein, which, when executed on a processor of a radiometric fill level measuring device, instructs the radiometric fill level measuring device to carry out a method according to claim 1.
